(19) United States
(12) Patent Application Publication
(10) Pub. No.: US 2014/0211227 A1
(43) Pub. Date: Jul. 31, 2014

(54) Methods and Systems for Monitoring an Image Capturing Device

(71) Applicant: HEWLETT-PACKARD INDIGO, B.V., Amstelveen (NL)

(72) Inventors: Tsafrir Yedid Am, Nes Ziona (IL); Tair Atzmon, Nes Ziona (IL); Dmitry Iofe, Nes Ziona (IL)

(73) Assignee: HEWLETT-PACKARD INDIGO, B.V., Amstelveen (NL)

(21) Appl. No.: 13/754,157

(22) Filed: Jan. 30, 2013

(51) Int. Cl. H04N 1/00

(52) U.S. Cl. CPC H04N 1/00023
USPC 358/1.13; 358/504

(57) ABSTRACT

A method and system for monitoring an image capturing device determines a distortion of an image of a printing medium, wherein the image is captured by means of an image capturing device, such as an in-line camera or scanner, and wherein the image comprises a calibration pattern with a plurality of calibration marks printed on the printing medium. The calibration pattern comprises at least a first sub-set of calibration marks relating to a first separation and a second sub-set of calibration marks relating to a second separation. The distortion is determined by analyzing the first sub-set of calibration marks, and the image is corrected based on said determined distortion. The displacement of the second sub-set of calibration marks with respect to the first sub-set of calibration marks may then be determined. The invention may be employed in a wide range of printers and presses.

### BACKGROUND

When multi-color information is to be imaged or printed in a printer or press, a final compound color is generally obtained by superimposing print separations that each have a different basic color. Depending on the application, three, four, five or even more separations may be employed and may be printed consecutively on a printing medium. The superposition or alignment of print separations gives the impression of a full color image having colors that may be different from the basic colors. However, this requires that the pixels of the different color separations be properly aligned with each other. The alignment process and the alignment itself are called registration. Color plane registration (CPR) errors can cause visible print artifacts, if the alignment error is greater than some threshold level, for instance 50 microns. The CPR error tend to vary over time and when the printed image or printing conditions change, such as when printing on different types of paper.

Modern printing systems, such as digital presses and high speed printers, have therefore been equipped with automated means to regularly measure the CPR errors. For instance, calibration marks may be printed on a test page, and an imaging device, such as an in-line scanner or camera, captures an image of the printed marks. The image may then be analyzed to determine the CPR error. For instance, the distance between the printed separation marks of different color separations or the optical density of the printed marks may be measured and analyzed to determine a mis-registration between different separations. Once the CPR error has been determined, the printing system can be adjusted to correct for the error.

However, even with these corrections the printing results are often still unsatisfactory.

### BRIEF DESCRIPTION OF THE DRAWINGS

FIG. 1 is a schematic diagram of a printing device comprising a system for monitoring and calibrating an image capturing device according to an example of the present invention.

FIGS. 2a and 2b illustrate an exemplary calibration pattern used for color plane registration, wherein FIG. 2a shows an ideal pattern and FIG. 2b shows a pattern with vertical and horizontal scaling errors.

FIGS. 3a and 3b illustrate the effects of horizontal (FIG. 3a) and vertical (FIG. 3b) scaling errors that may be due to drift of the image capturing device.

FIG. 3c illustrates the effects of tilt errors in an image capturing device.

FIGS. 4 to 8 illustrate a sequence of steps for determining a distortion of an image of a printing medium and correcting said image based on said determined distortion according to an embodiment of the present invention.

FIG. 9 is a flow diagram that illustrates a method for monitoring and calibrating an image capturing device according to an embodiment of the present invention.

### DETAILED DESCRIPTION

A method for monitoring an image capturing device according to an example comprises a step of determining a distortion of an image of a printing medium, said image being an image that has been captured by means of an image capturing device, wherein said image comprises a calibration pattern with a plurality of calibration marks printed on said printing medium, said calibration pattern comprising at least a first sub-set of calibration marks relating to a first separation and a second sub-set of calibration marks relating to a second separation. Said distortion is determined by analyzing said first sub-set of calibration marks, and said image is corrected based on said determined distortion. The method further comprises a step of determining a displacement of said second sub-set of calibration marks with respect to said first sub-set of calibration marks.

A printing medium may be any medium onto which an image with a calibration pattern may be applied. The printing medium may be a sheet of paper fed into a printer. However, the printing medium may also be an intermediate transfer medium that bears an image before it is being passed on or transferred to some other medium. An example of a transfer medium is a transfer drum in a press.

In an example, said distortion comprises a tilt and/or a horizontal scaling and/or a vertical scaling of said first sub-set of calibration marks.

Said first separation and said second separation may be printed consecutively.

Said first separation and said second separation may be printed consecutively either on a printing medium such as a sheet of paper, or on a transfer medium from which the separations are subsequently transferred to the printing medium.

Said calibration pattern may further comprise a third sub-set of calibration marks relating to a third separation, and said method may comprise a step of determining a displacement of said third sub-set of calibration marks with respect to said first sub-set of calibration marks.

In an example, said distortion may be determined by analyzing only said first sub-set of calibration marks. In particular, said distortion may be determined without analyzing said second sub-set and/or further sub-sets of calibration marks.

The step of correcting said image based on said determined distortion may comprise the step of correcting both said first sub-set of calibration marks and said second sub-set of calibration marks, and possibly further sub-sets of calibration marks.

In an example, said first sub-set of calibration marks comprises a plurality of calibration marks arranged in an array of rows and columns. The calibration marks may include circles or squares, or any other suitable geometric form.

Said step of analyzing said first sub-set of calibration marks may comprise the steps of determining horizontal and/or vertical distances between neighboring calibration marks, and comparing the distances with predetermined reference distances.

In an example, said step of analyzing said first sub-set of calibration marks may comprise a step of fitting said plurality of calibration marks to a grid pattern. The fitting may comprise a least-mean-square fit.

In an example said step of analyzing said first sub-set of calibration marks may comprise a step of determining a horizontal tilt angle and/or vertical tilt angle of said grid pattern with respect to a predetermined reference direction.

Said step of correcting said image may comprise the steps of determining horizontal and/or vertical distances in said grid pattern, comparing said horizontal and/or vertical distances to predetermined reference distances to determine horizontal and/or vertical scaling factors, and applying said scaling factors to said first sub-set of calibration marks to obtain a corrected grid pattern. Said scaling factors may further be applied to said second sub-set of calibration marks, and possibly to further sub-sets of calibration marks.

In an example, said step of determining said displacement of said second sub-set of calibration marks with respect to said first sub-set of calibration marks may comprise a step of comparing said second sub-set of calibration marks to which said scaling factors have been applied with said corrected grid pattern.

Said second sub-set of calibration marks may comprise at least one calibration mark, in particular a circle or a square.

Said distortion of said calibration pattern may be determined and corrected continuously or at regular intervals for a plurality of printing media printed consecutively. In particular, the method according to the present invention allows an image capturing device of a printing system or a press to self-monitor distortions and to auto-calibrate continuously to compensate for tilt and/or scaling errors.

Said displacement of said second sub-set of calibration marks with respect to said first sub-set of calibration marks may likewise be determined continuously or at regular intervals for said plurality of printing media printed consecutively.

In an example, the method further comprises the step of printing said calibration pattern on said printing medium and/or the step of capturing an image of said calibration pattern by means of said image capturing device.

In this aspect, the improvement may relate to a method for monitoring an image capturing device, comprising the steps of printing a calibration pattern comprising a plurality of calibration marks on a printing medium, said calibration pattern comprising at least a first sub-set of calibration marks relating to a first separation and a second sub-set of calibration marks relating to a second separation. The method according to this aspect further comprises the steps of capturing an image of said calibration pattern by means of an image capturing device, determining a distortion of said image by analyzing said first sub-set of calibration marks, wherein said distortion comprises at least a tilt and/or a scaling of said calibration pattern, correcting said image based on said determined distortion, and determining a displacement of said second sub-set of calibration marks with respect to said first sub-set of calibration marks based on said corrected image.

The invention also relates to a system for monitoring an image capturing device, said system comprising an evaluation means to determine a distortion of an image of a printing medium, said image having been captured by means of an image capturing device, wherein said image comprises a calibration pattern with a plurality of calibration marks printed on said printing medium, wherein said calibration pattern comprises at least a first sub-set of calibration marks relating to a first separation and a second sub-set of calibration marks relating to a second separation. Said evaluation means determines said distortion by analyzing said first sub-set of calibration marks. The system further comprises a correction means to correct said image based on said determined distortion, and to determine a displacement of said second sub-set of calibration marks with respect to said first sub-set of calibration marks.

In an example, said evaluation means determines a tilt and/or a scaling of said first sub-set of calibration marks.

The system may further comprise a printing means to print said calibration pattern comprising said plurality of calibration marks on said printing medium.

The system may also comprise said image capturing device to capture said image of said calibration pattern.

In an aspect, the improvement relates to a printing device comprising a printing means to print a calibration pattern on a printing medium, said calibration pattern comprising at least a first sub-set of calibration marks relating to a first separation and a second sub-set of calibration marks relating to a second separation. In this aspect, the printing device may further comprise an image capturing device to capture an image of said calibration pattern, an evaluation means to determine a distortion of said image, wherein said distortion comprises at least a tilt and/or a scaling of said calibration pattern and wherein said evaluation means determines said distortion by analyzing said first sub-set of calibration marks, and a correction means to correct said image based on said determined distortion, and to determine a displacement of said second sub-set of calibration marks with respect to said first sub-set of calibration marks.

Said image capturing device may comprise a camera and/or a scanner, in particular an in-line camera or an in-line scanner.

The improvement also relates to a computer-readable medium comprising computer-readable instructions, wherein said computer-readable instructions, when read in a computer device, cause said computer device to perform a method with some or all of the steps as described above.

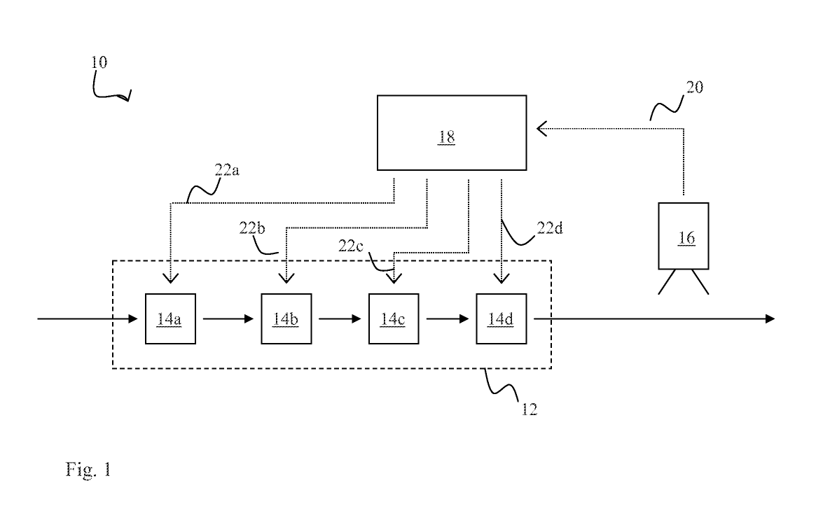

Examples will now be described in greater detail with reference to FIGS. 1 to 9 for the specific example of a calibration pattern for use in a high speed printer or a press. However, the invention is not so limited, and may be employed in various other contexts as well, whenever a set of calibration marks shall be analyzed by means of an image capturing device, such as a camera or a scanner.

FIG. 1 is a schematic illustration of an example of a press 10 in which the invention may be employed. The press 10 may comprise an imaging device 12 in which a plurality of imaging stations 14a to 14d are provided. A printing medium or printing substrate such as a sheet of paper, is fed into the imaging device 12 at the first imaging station 14a, and is then passed on from imaging station to imaging station until it leaves the last imaging station 14d. The path of the printing medium through the press 10 is schematically indicated in FIG. 1 by solid arrows.

Each of the imaging stations 14a to 14d corresponds to a different print separation with a different basic color. The different separations are printed consecutively, and the full color image that results is a superposition of the different print separations. The schematic illustration of FIG. 1 shows four imaging stations corresponding to four different separations, i.e., four different basic colors. For instance, the first imaging station 14a may correspond to black color, the second imaging station 14b may correspond to cyan, the third imaging station 14c may correspond to magenta and the forth imaging station 14d may correspond to yellow. However, this is a mere example, and depending on the application a smaller or larger number of separations may also be employed, and in any order.

However, the schematic drawing of FIG. 1 should not be understood to imply that the imaging stations 14a to 14d are necessarily spatially or otherwise separated. The schematic representation of FIG. 1 also applies to configurations in which each color separation is layed down one after the other on a photoconductor drum, then to an intermediate transfer drum, and from there to the substrate. In this latter configuration, the stations 14a to 14d can be thought of as representing subsequent steps or stations of laying down the color separations on the photoconductor drum, or some other transfer medium. The solid arrows in FIG. 1 then no longer represent the path of the printing medium, but rather illustrate the steps of applying the separations consecutively to the transfer medium, with a subsequent step (not shown) of transferring the image from the transfer medium to the substrate, possibly via a plurality of further intermediate transfer media.

### Color Plane Registration

The printing medium with the superimposed image may be captured by means of an image capturing device, such as an in-line camera 16. The image data is passed to a control device 18 via a data line 20. The control device 18 checks the alignment and the superposition of the print separations, and may adjust the print settings at each of the imaging stations 14a to 14d via respective control lines 22a to 22d, if the separations are printed out of registration. This process is usually called color plane registration, and is described in further detail in related applications U.S. Pat. No. 6,456,311 B1, U.S. Pat. No. 7,679,630 B2, and US 2012/0105876 A1.

Conventional color plane registration often involves the printing of designated calibration patterns on a printing medium that facilitate to check whether the color separations are properly aligned. Such calibration patterns typically comprise calibration marks of each of the basic colors, which may be printed either on designated test pages or in the side margins and/or top margins of regular print pages. Some such calibration patterns and their analysis are described in further detail in U.S. '630 and U.S. '876. Modern presses or high speed printers sometimes print calibration patterns on every single page that is printed, to allow for a continuous analysis and correction of the color plane registration.

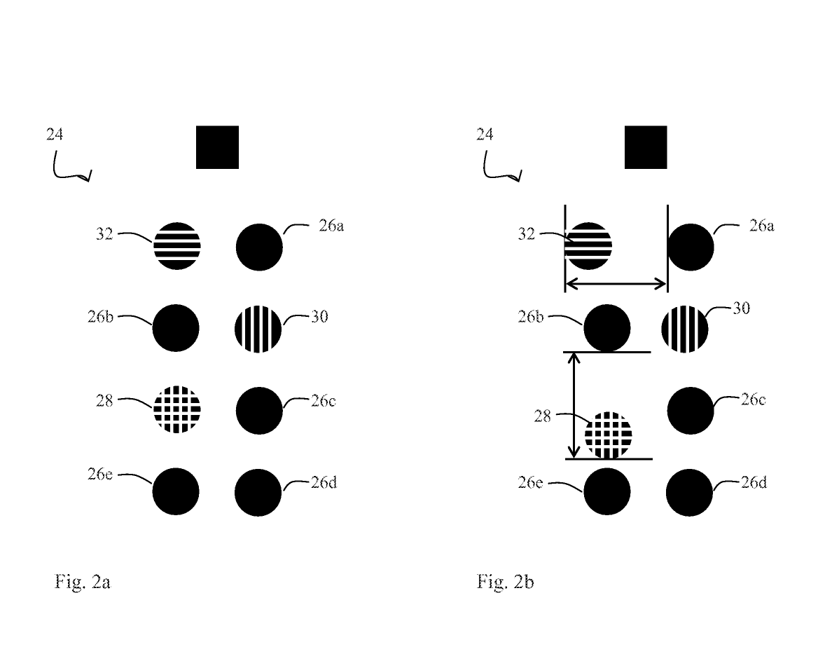

An exemplary calibration pattern 24 as it may be printed in the top margin or side margin of a printing medium is shown in FIG. 2a. The calibration pattern 24 comprises a square calibration mark and a plurality of circular calibration marks arranged in rows and columns. However, this is a mere example, and other geometric shapes or other patterns may be employed, depending on the application. The calibration pattern 24 in FIG. 2a comprises a plurality of black calibration marks 26a to 26e that correspond to the black separation and may be printed onto the printing medium or transfer medium first. The calibration pattern 24 further comprises a cyan calibration mark 28, a magenta calibration mark 30, and a yellow calibration mark 32, wherein the calibration marks are arranged such that each of the non-black calibration marks 28, 30, 32 has a neighboring black calibration mark both along the vertical direction and along the horizontal direction. In FIG. 2a, the non-black calibration marks 28, 30, 32 are represented by different hatchings. However, this is for illustration only in the black-and-white drawings, and in a real pattern these calibration marks would be circular dots in the respective colors cyan, magenta and yellow.

In the calibration pattern 24, the black calibration marks 26a to 26e form a first sub-set that serves as a reference against which deviations of the other calibration marks 28, 30 and 32 may be measured. FIG. 2a illustrates a perfect or ideal calibration pattern 24, in which all the separations are perfectly aligned without CPR errors. This is the target configuration, but it is not what is usually seen in a press during operation. Typically, the different separations are slightly misaligned. An example is shown in FIG. 2b, with a vertical mis-registration of the cyan calibration mark 28 and a horizontal mis-registration of the yellow calibration mark 32 with respect to the black reference pattern 26a-26e. When an image is taken of the calibration pattern 24 shown in FIG. 2b by the in-line camera 16 and sent for analysis to the control device 18, the cyan and yellow mis-registrations may be detected, and the control device 18 may send correction signals via control data lines 22b and 22d to readjust the cyan and yellow imaging stations 14b and 14d, respectively, such that the ideal configuration shown in FIG. 2a is restored. Reference is again made to U.S. Pat. No. 6,456,311, U.S. Pat. No. 7,679,630, and US 2012/0105876, which describe the CPR correction in further detail.

### Monitoring the Image Capturing Device

The inventors found that one reason for the persistence of CPR errors despite the measures described above are distortions in the image capturing device itself, such as horizontal scaling, vertical scaling and skew alignment errors of the in-line camera 16 or in-line scanner. Such errors may be due to imprecise assembly of the device, but may also be due to drift over time and noise and tilt along the print run. Although the in-line camera 16 is calibrated to be perfectly aligned, this procedure has limited accuracy and cannot result in zero tilt. In addition, the in-line camera 16 may suffer from drift along time and noise and tilt along run. The distortion of the imaging capturing device field of view can also suffer from drift along run, which may result in horizontal and vertical scaling.

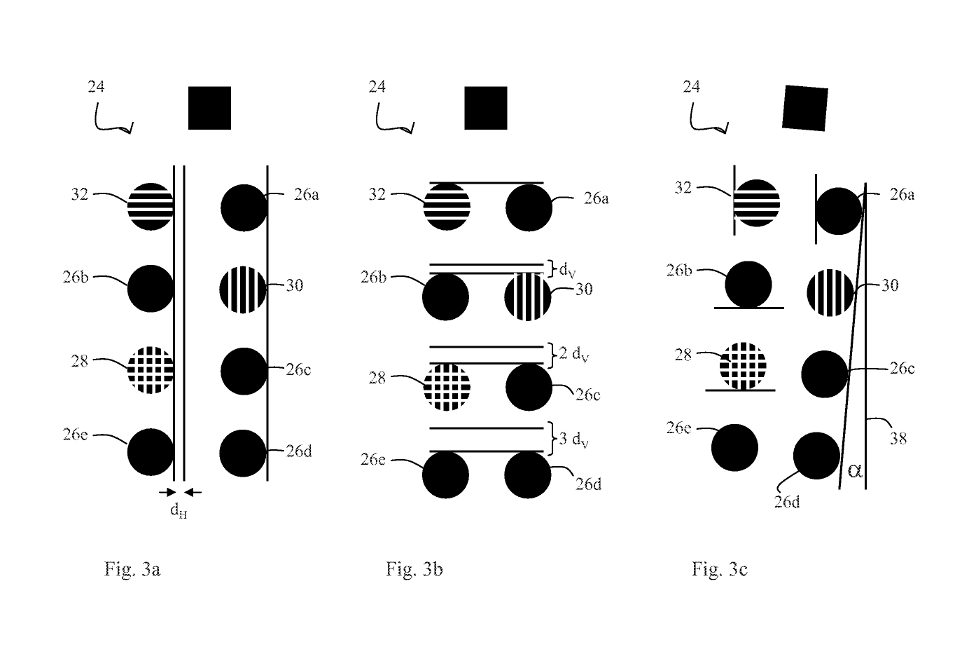

FIG. 3a shows an image of the ideal calibration pattern shown in FIG. 2a, but taken with an in-line camera 16 that has a horizontal scaling error. The horizontal scaling error results in a larger separation of the calibration marks in the horizontal direction by distance d_{H}. The control device 18 may mis-represent the horizontal scaling as a CPR error and may erroneously correct the imaging device 12. Similarly, FIG. 3b shows an image of the perfect calibration pattern shown in FIG. 2a, but taken with an in-line camera 16 that has a vertical distortion. As a result, the distance between each two neighboring calibration marks is enlarged by the distance dᵥ in the vertical direction. Again, the control device 18 may misinterpret the vertical scaling as a CPR error and may erroneously correct the alignment in the imaging device 12.

FIG. 3c shows another image of the perfect calibration pattern shown in FIG. 2a, but taken with an in-line camera that has a tilt error. As can be taken from FIG. 3c, the image is tilted by an angle α with respect to a vertical reference direction 38. The tilt of the camera by the angle α may again be interpreted as a horizontal and vertical mis-registration, since all nominal distances will be scaled by cos α.

Distortions in the image capturing device 16 may hence lead to erroneous color plane registration correction, which may introduce rather than correct registration errors.

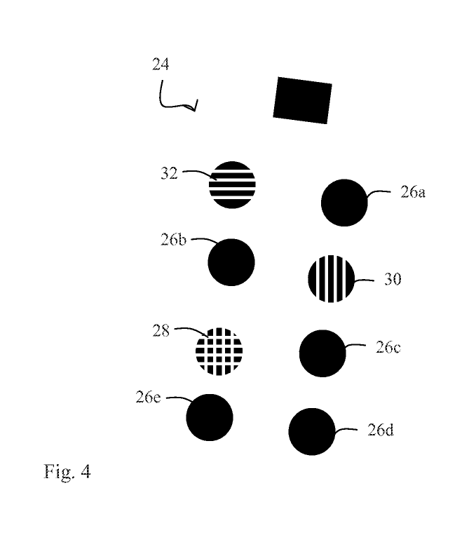

The inventors found that these errors may be avoided with a method and system for monitoring and calibrating the image capturing device, using a first sub-set of calibration marks as a reference to correct for scaling and tilt errors introduced by the image capturing device. An example of the method and system according to the invention will now be described in detail with reference to FIGS. 4 to 9.

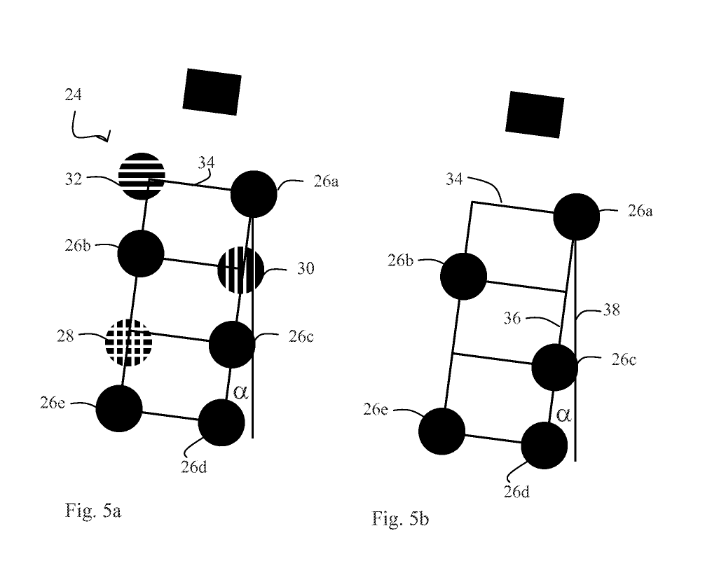

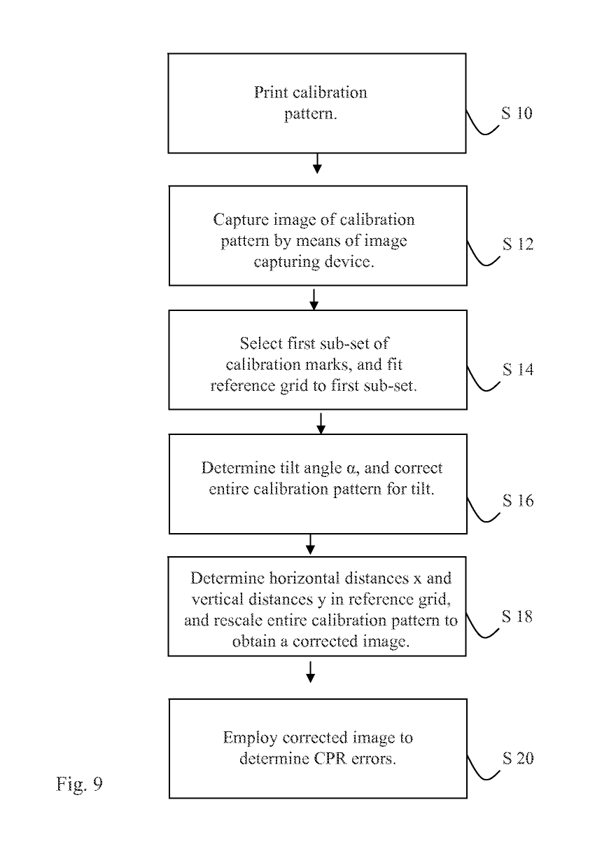

FIG. 4 shows an example of a calibration pattern 24 that was printed on a substrate with the imaging device 12 of FIG. 1 (Step S10 in FIG. 9), and was captured with the in-line camera 16 (Step S12). The calibration pattern 24 has registration errors, but in addition has distortions introduced by the in-line camera 16. In order to correct for the distortions introduced by the in-line camera 16, the first subset of black calibration marks 26a to 26e is singled out as a reference pattern, and a reference grid 34 is fitted to the black calibration marks 26a to 26e, as shown in FIGS. 5a and 5b (Step S 14 in FIG. 9). FIG. 5b shows the black calibration marks 26a to 26e only without the colored registration marks to better illustrate that the reference grid 34 is based on these calibration marks only, and not on the calibration marks 28, 30 and 32 of the other separations, which may be distorted relative to the black reference marks due to CPR errors. However, the reference pattern does not necessarily need to consist of the black calibration marks, and any other separation or calibration marks may likewise be employed as a reference.

The reference grid 34 may be determined by first determining the centers of each of the circular calibration marks 26a to 26e, and then fitting a rectangular grid to the circles, wherein the vertices of the grid correspond to the centers of the circles. The fit may involve a least-mean-square fit, but other techniques may be employed as well.

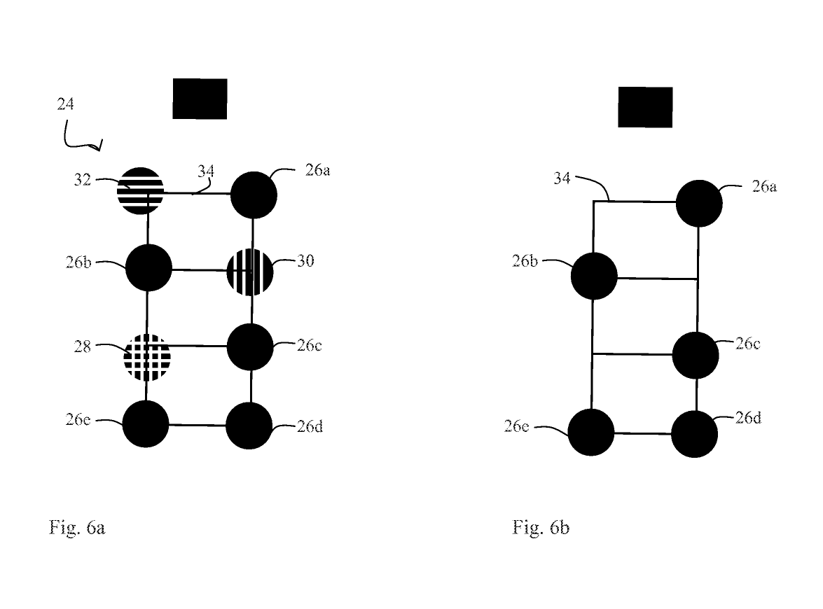

Once the reference grid 34 has been obtained, a tilt angle α between the reference grid 34 and a horizontal or vertical reference direction is determined. As illustrated in FIG. 5a and FIG. 5b, the tilt angle α may be the angle between predetermined side edge 36 of the reference grid 34 and the vertical reference direction 38. Once the tilt angle α has been determined, the reference grid and the entire calibration pattern 24, comprising both the reference calibration marks 26a to 26e and the further calibration marks 28, 30 and 32, are tilted by the angle −α to correct for the tilt (Step S 16 in FIG. 9). The resulting (rotated) calibration pattern is shown in FIGS. 6a and 6b, where again FIG. 6b for illustrating purposes shows only the calibration marks 26a to 26e that serve as a reference.

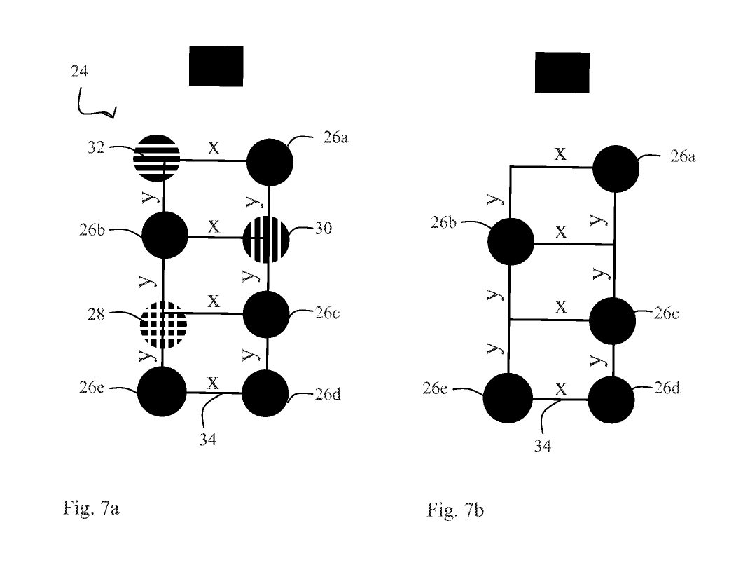

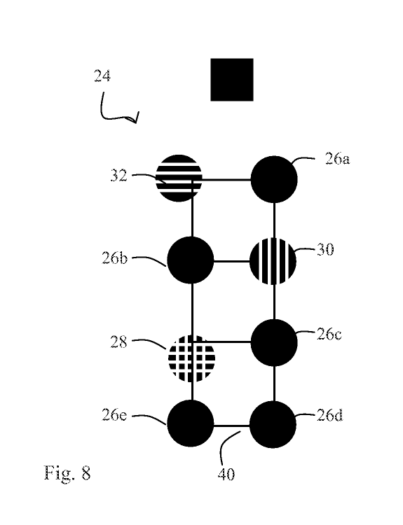

Next, the horizontal distances x and the vertical distances y between neighboring vertices in the reference grid 34 are determined, as illustrated in FIGS. 7a and 7b. Again, FIG. 7b shows the black calibration marks 26a to 26e only to illustrate that the reference grid 34, and hence the horizontal distances x and vertical distances y are computed based on these reference marks only. The measured horizontal distance x is then compared to the nominal distance x₀ of the ideal calibration pattern 24 shown in FIG. 2a, and similarly the measured vertical distance y is compared to the nominal distance y₀ of the ideal pattern. The entire calibration pattern, comprising the black calibration marks 26a to 26e as well as the further calibration marks 28, 30, 32 is now scaled by the factor x₀/x in the horizontal direction, and by a factor y₀/y in the vertical direction (Step S 18 in FIG. 9). The resulting (corrected) image is shown in FIG. 8.

The corrected image shown in FIG. 8 may now be employed to determine the misalignment of the cyan calibration mark 28, the magenta calibration mark 30 and the yellow calibration mark 32 with respect to the black reference pattern 26a to 26e (Step S 20 in FIG. 9) employing the techniques described above with reference to FIGS. 2a and 2b. As shown in FIG. 8, the cyan calibration mark 28 and the yellow calibration mark 32 are each displaced with respect to the black reference marks 26a to 26e both along the horizontal and vertical directions and hence need corrections, whereas the magenta calibration mark 30 is already perfectly aligned with the reference marks and hence does not require further correction. Based on this analysis, the control device 18 may send correction parameters via data lines 22b and 22d to the cyan and yellow imaging stations 14b and 14d, respectively to correct the alignment. After correction of the alignment, all the separations will be perfectly aligned, corresponding to the ideal calibration pattern 24 shown in FIG. 2a.

The control device 18 may store the determined tilt angle α and the horizontal and vertical scaling factors x₀/x and y₀/y determined from the reference grid 34 to process further data captured by the in-line camera 16. The calibration pattern 24 may be printed in the top margin or side margin of every page that is printed. Every page may then be captured by means of the in-line camera 16, and forwarded for analysis to the control device 18 via data line 20. Every printed calibration pattern may hence be analyzed as described with reference to FIGS. 4 to 9 above. This allows to implement a continuous self-monitoring and self-calibration of the image capturing device 16 based on a real time evaluation of the current data. Alternatively, the calibration pattern may only be printed at regular time intervals, such as every two hours, or at regular printing intervals, such as every 1.000 sheets, and the camera distortion may only be analyzed at these intervals.

The description of the preferred embodiments and the Figures merely serves to illustrate the invention and the numerous advantages it entails, but should not be understood to imply any limitation. The scope of the invention is to be determined solely by means of the appended claims.

### REFERENCE SIGNS

10 press
12 imaging device
14a-14d imaging stations
16 in-line camera
18 control device
20 data line
22a-22d control data lines
24 calibration pattern
26a-26e black calibration marks
28 cyan calibration mark
30 magenta calibration mark
32 yellow calibration mark
34 reference grid
36 side edge of reference grid 34
38 vertical reference direction
40 corrected reference grid

1. A method for monitoring an image capturing device, comprising the steps of:
determining a distortion of an image of a printing medium, said image captured by means of an image capturing device;
wherein said image comprises a calibration pattern, wherein said calibration pattern comprises a plurality of calibration marks printed on said printing medium, said calibration pattern comprising at least a first sub-set of calibration marks relating to a first separation and a second sub-set of calibration marks relating to a second separation;
wherein said distortion is determined by analyzing said first sub-set of calibration marks;
correcting said image based on said determined distortion; and
determining a displacement of said second sub-set of calibration marks with respect to said first sub-set of calibration marks.

2. The method according to claim 1, wherein said distortion comprises a tilt and/or horizontal scaling and/or vertical scaling of said first sub-set of calibration marks.

3. The method according to claim 1, wherein said first separation and said second separation are printed consecutively.

4. The method according to claim 1, wherein said calibration pattern further comprises a third sub-set of calibration marks relating to a third separation, and said method comprises a step of determining a displacement of said third sub-set of calibration marks with respect to said first sub-set of calibration marks.

5. The method according to claim 1, wherein said distortion is determined by analyzing only said first sub-set of calibration marks, in particular without analyzing said second sub-set and/or further sub-sets of calibration marks.

6. The method according to claim 1, wherein said step of correcting said image based on said determined distortion comprises correcting both said first sub-set of calibration marks and said second sub-set of calibration marks, and possibly further sub-sets of calibration marks.

7. The method according to claim 1, wherein said first sub-set of calibration marks comprises a plurality of calibration marks arranged in an array of rows and columns, in particular a plurality of circles or squares.

8. The method according to claim 7, wherein said step of analyzing said first sub-set of calibration marks comprises the steps of determining horizontal and/or vertical distances between neighboring calibration marks, and comparing said distances with predetermined reference distances.

9. The method according to claim 7, wherein said step of analyzing said first sub-set of calibration marks comprises a step of fitting said plurality of calibration marks to a grid pattern, in particular by means of a least-mean-square fit.

10. The method according to claim 9, wherein said step of analyzing said first sub-set of calibration marks further comprises a step of determining a horizontal tilt angle and/or a vertical tilt angle (α) of said grid pattern with respect to a predetermined reference direction.

11. The method according to claim 9, wherein said step of correcting said image comprises the steps of determining horizontal (x) and/or vertical (y) distances in said grid pattern, comparing said horizontal (x) and/or vertical (y) distances to predetermined reference distances (x₀, y₀) to determine horizontal and/or vertical scaling factors, and applying said scaling factors to said first sub-set of calibration marks to obtain a corrected grid pattern, to said second sub-set of calibration marks, and possibly to further sub-sets of calibration marks.

12. The method according to claim 11, wherein said step of determining said displacement of said second sub-set of calibration marks with respect to said first sub-set of calibration marks comprises the step of comparing said second sub-set of calibration marks to which said scaling factors are applied with said corrected grid pattern.

13. The method according to claim 1, wherein said second sub-set of calibration marks comprises at least one calibration mark, in particular a circle or square.

14. The method according to claim 1, wherein said distortion of said calibration pattern is determined and corrected continuously or at regular intervals for a plurality of printing media printed consecutively.

15. The method according to claim 1, further comprising the step of printing said calibration pattern on said printing medium, and/or the step of capturing an image of said calibration pattern by means of said image capturing device.

16. A system for monitoring an image capturing device, said system comprising:
an evaluation means to determine a distortion of an image of a printing medium, said image captured by means of an image capturing device;
wherein said image comprises a calibration pattern, wherein said calibration pattern comprises a plurality of calibration marks printed on said printing medium, said calibration pattern comprising at least a first sub-set of calibration marks relating to a first separation and a second sub-set of calibration marks relating to a second separation;
wherein said evaluation means determines said distortion by analyzing said first sub-set of calibration marks; and
a correction means to correct said image based on said determined distortion, and to determine a displacement of said second sub-set of calibration marks with respect to said first sub-set of calibration marks.

17. The system according to claim 16, wherein said evaluation means determines a tilt and/or scaling of said first sub-set of calibration marks.

18. A printing device, comprising:
a printing means to print a calibration pattern on a printing medium, said calibration pattern comprising at least a first sub-set of calibration marks relating to a first separation and a second sub-set of calibration marks relating to a second separation;
an image capturing device to capture an image of said calibration pattern;
an evaluation means to determine a distortion of said image, wherein said distortion comprises at least a tilt and/or a scaling of said calibration pattern and wherein said evaluation means determines said distortion by analyzing said first sub-set of calibration marks; and
a correction means to correct said image based on said determined distortion, and to determine a displacement of said second sub-set of calibration marks with respect to said first sub-set of calibration marks.

19. The printing device according to claim 18, wherein said image capturing device comprises a camera and/or scanner.

20. A computer-readable medium comprising computer-readable instruction, wherein said computer-readable instructions, when read in a computer device, cause said computer device to perform a method according to claim 1.
